(19) United States
(12) Patent Application Publication
(10) Pub. No.: US 2021/0081920 A1
(43) Pub. Date: Mar. 18, 2021

(54) SYSTEMS AND METHODS FOR DETERMINING A MODE OF FINANCIAL TRANSACTION BASED ON IDENTIFIERS ASSOCIATED WITH PARTICIPANTS OF THE FINANCIAL TRANSACTION

(71) Applicant: Capital One Services, LLC, McLean, VA (US)

(72) Inventors: MICHAEL SPINA, Wilmington, DE (US); Karen Tien, Washington, DC (US)

(73) Assignee: Capital One Services, LLC, McLean, VA (US)

(21) Appl. No.: 16/570,564

(22) Filed: Sep. 13, 2019

(51) Int. Cl. G06Q 20/22; G06N 20/00; G06Q 20/40; G06Q 20/04

(52) U.S. Cl. CPC G06Q 20/227; G06Q 20/042; G06Q 20/405; G06N 20/00

(57) ABSTRACT

A system for automatically determining a mode of financial transaction to utilize for a financial transaction based on account identifiers associated with participants of the financial transaction to generate and present at a user device, a financial transfer interface in response to receiving from the user device a financial transfer initiation request for a financial transfer. The system determines a plurality of modes of financial transaction to perform the financial transfer based on the selected recipient account identifier, wherein at least one of the plurality of modes of financial transaction includes one or more transfer parameters, and ranks and displays by rank on the financial transfer interface the plurality of modes of financial transaction based on one or more transaction rules associated with the one or more transfer parameters.

### TECHNICAL FIELD

Embodiments of the present disclosure relate to systems and methods for automatically determining a mode of financial transaction to utilize for a financial transaction. More particularly, embodiments of the present disclosure relate to automatically determining a mode of financial transaction to utilize for a financial transaction based on account identifiers associated with participants of the financial transaction.

### BACKGROUND

Users (e.g., online banking customers) often use banking websites or banking mobile applications to transfer money between accounts. By way of example, when a user would like to transfer $1000 from his bank account, the user needs to enter the account information for the recipient account and then provide information on what type of transaction the user is interested in (e.g., direct deposit, wire transfer, mailing a check, etc). In this case, the entire process of transferring the money is inefficient as the process is not customized specific to a user needs and results in time consuming and tedious tasks.

### SUMMARY

In accordance with embodiments of the present disclosure, there is provided a system for automatically determining a mode of financial transaction to utilize for a financial transaction based on account identifiers associated with participants of the financial transaction, the system comprising: one or more memory devices storing instructions; and one or more processors configured to execute the instructions to: generate and present at a user device, a financial transfer interface in response to receiving from the user device a financial transfer initiation request for a financial transfer, wherein the financial transaction comprises the financial transfer; receive, from the user device, a selection of a sender account corresponding to a sender participant from a list of sender accounts displayed on the financial transfer interface; apply a machine learning algorithm to recommend, by displaying on the financial transfer interface, a list of recipient account identifiers corresponding to a plurality of recipient participants of the financial transfer based on analyzing one or more account parameters associated with the sender participant of the financial transfer; receive a selection of one recipient account identifier from the recommended list of recipient account identifiers from the user device, wherein the selected recipient account identifier corresponds to one recipient participant from the plurality of recipient participants; determine a plurality of modes of financial transaction to perform the financial transfer based on the selected recipient account identifier, wherein at least one of the plurality of modes of financial transaction includes one or more transfer parameters; rank and display by rank on the financial transfer interface the plurality of modes of financial transaction based on one or more transaction rules associated with the one or more transfer parameters; receive a selection of one mode of financial transaction from the plurality of modes of financial transaction from the user device; receive a transfer amount for the financial transfer via the financial transfer interface as an input from the user device; and upon receiving a transfer confirmation request from the user device, transfer the transfer amount from the sender account corresponding to the sender participant to the selected recipient account identifier corresponding to one of the recipient participants by utilizing the selected mode of financial transaction.

In accordance with embodiments of the present disclosure, there is also provided a computer implemented method for automatically determining a mode of financial transaction to utilize for a financial transaction based on account identifiers associated with participants of the financial transaction, the method comprising: generating and presenting at a user device, a financial transfer interface in response to receiving from the user device a financial transfer initiation request for a financial transfer, wherein the financial transaction comprises the financial transfer; receiving, from the user device, a selection of a sender account corresponding to a sender participant from a list of sender accounts displayed on the financial transfer interface; applying a machine learning algorithm to recommend, by displaying on the financial transfer interface, a list of recipient account identifiers corresponding to a plurality of recipient participants of the financial transfer based on analyzing one or more account parameters associated with the sender participant of the financial transfer; receiving a selection of one recipient account identifier from the recommended list of recipient account identifiers from the user device, wherein the selected recipient account identifier corresponds to one recipient participant from the plurality of recipient participants; determining a plurality of modes of financial transaction to perform the financial transfer based on the selected recipient account identifier, wherein at least one of the plurality of modes of financial transaction includes one or more transfer parameters; ranking and displaying by rank on the financial transfer interface the plurality of modes of financial transaction based on one or more transaction rules associated with the one or more transfer parameters; receiving a selection of one mode of financial transaction from the plurality of modes of financial transaction from the user device; receiving a transfer amount for the financial transfer via the financial transfer interface as an input from the user device; and upon receiving a transfer confirmation request from the user device, transferring the transfer amount from the sender account corresponding to the sender participant to the selected recipient account identifier corresponding to one of the recipient participants by utilizing the selected mode of financial transaction.

In accordance with embodiments of the present disclosure, there is further provided a non-transitory computer-readable medium storing instructions executable by one or more processors to perform operations for automatically determining a mode of financial transaction to utilize for a financial transaction based on account identifiers associated with participants of the financial transaction, the operations comprising: generating and presenting at a user device, a financial transfer interface in response to receiving from the user device a financial transfer initiation request for a financial transfer, wherein the financial transaction comprises the financial transfer; receiving, from the user device, a selection of a sender account corresponding to a sender participant from a list of sender accounts displayed on the financial transfer interface; applying a machine learning algorithm to recommend, by displaying on the financial transfer interface, a list of recipient account identifiers corresponding to a plurality of recipient participants of the financial transfer based on analyzing one or more account parameters associated with the sender participant of the financial transfer; receiving a selection of one recipient account identifier from the recommended list of recipient account identifiers from the user device, wherein the selected recipient account identifier corresponds to one recipient participant from the plurality of recipient participants; determining a plurality of modes of financial transaction to perform the financial transfer based on the selected recipient account identifier, wherein at least one of the plurality of modes of financial transaction includes one or more transfer parameters; ranking and displaying by rank on the financial transfer interface the plurality of modes of financial transaction based on one or more transaction rules associated with the one or more transfer parameters; receiving a selection of one mode of financial transaction from the plurality of modes of financial transaction from the user device; receiving a transfer amount for the financial transfer via the financial transfer interface as an input from the user device; and upon receiving a transfer confirmation request from the user device, transferring the transfer amount from the sender account corresponding to the sender participant to the selected recipient account identifier corresponding to one of the recipient participants by utilizing the selected mode of financial transaction.

### BRIEF DESCRIPTION OF DRAWINGS

The accompanying drawings, which are incorporated in and constitute a part of his specification, illustrate disclosed embodiments and, together with the description, serve to explain the disclosed embodiments. In the drawings:

FIG. 1 is a block diagram of an exemplary system, consistent with disclosed embodiments;

FIG. 2 is a block diagram of an exemplary user device, consistent with disclosed embodiments;

FIG. 3 is a block diagram of an exemplary server system, consistent with disclosed embodiments;

FIGS. 4A-4C contain a flowchart of an exemplary process of automatically determining a mode of financial transaction to utilize for a financial transaction based on account identifiers associated with participants of the financial transaction, consistent with disclosed embodiments;

FIGS. 5A-5C contain exemplary interfaces of an exemplary process of automatically determining a bill payment mode of a financial transaction based on account identifiers associated with participants of the financial transaction, consistent with disclosed embodiments;

FIGS. 6A-6C contain exemplary interfaces of an exemplary process for automatically determining multiple modes of money transfer based on account identifiers associated with participants of a financial transaction, consistent with disclosed embodiments;

FIGS. 7A-7C contain exemplary interfaces of an exemplary process for adding a mailing address for a money transfer and automatically determining multiple modes of money transfer based on account identifiers associated with participants of a financial transaction, consistent with disclosed embodiments; and

FIGS. 8A-8C contain exemplary interfaces of an exemplary process 400 for automatically determining a mode of requesting money transfer based on account identifiers associated with participants of a financial transaction, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

An initial overview of machine learning and prediction is first provided immediately below and then specific exemplary embodiments of systems, methods, and devices for automatically determining a mode of financial transaction to utilize for a financial transaction based on account identifiers associated with participants of the financial transaction are described in further detail. The initial overview is intended to aid in understanding technology relevant to the systems, methods, and devices disclosed herein, but it is not intended to limit the scope of the claimed subject matter.

In the field of machine prediction, there are two subfields: knowledge-based systems and machine-learning systems. Knowledge-based systems rely on the creation of a heuristic or rule-based system which is then applied to a particular problem or dataset. Knowledge based systems make inferences or decisions based on an explicit “if-then” rule system. Such systems rely on extracting a high degree of knowledge about a limited category, with a goal of providing all possible solutions to a given problem. These solutions are then embodied in a series of instructions to be sequentially followed by a machine.

Machine learning systems, unlike knowledge-based systems, provide machines with the ability to learn through data input without being explicitly programmed with rules. For example, conventional knowledge-based system programming relies on writing algorithms (i.e., rules) and programming instructions to execute each algorithm. Machine learning systems, on the other hand, make data-driven decisions to construct their own rules. The nature of machine learning is the iterative process of using rules, and creating new ones, to identify unknown relationships to better generalize and handle non-linear problems with incomplete input data sets. A detailed explanation of one exemplary machine learning technique is disclosed in the article: Michalski, R. S., Stepp, R. E. “Learning from Observation: Conceptual Clustering,” Chapter 11 of Machine Learning: An Artificial Intelligence Approach, eds. R. S. Michalski, J. G. Carbonell and T. M. Mitchell, San Mateo: Morgan Kaufmann, 1983 which is incorporated herein by reference. Embodiments of the present disclosure implement a recommendation model which uses machine learning.

While the following description is directed to automatically determining a mode of financial transaction to utilize for a financial transaction based on account identifiers associated with participants of the financial transaction, it should be appreciated that the present disclosure is not limited to the specific disclosed embodiments and details, which are exemplary only. It is further understood that one possessing ordinary skill in the art, would appreciate the use of the embodiments of the present disclosure for their intended purposes and benefits in any number of alternative embodiments, depending on specific design and other needs.

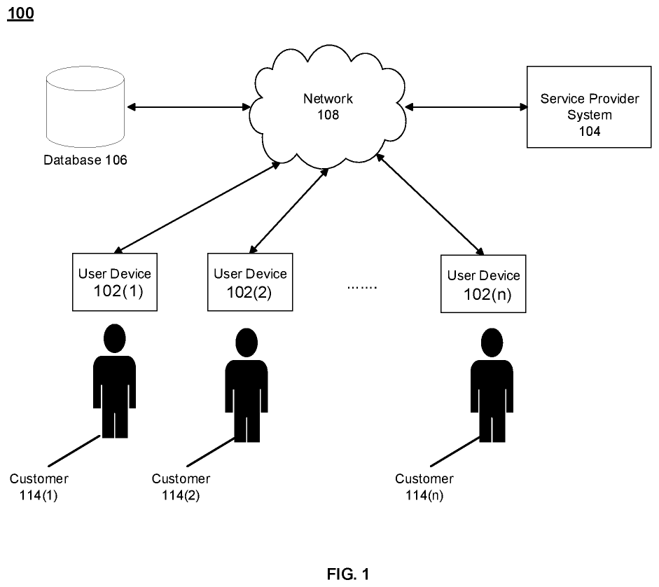

FIG. 1 is a block diagram of an exemplary system 100, for performing one or more operations consistent with disclosed embodiments. In some embodiments, system 100 includes one or more user devices 102(1), 102(2), . . . 102(n), one or more service provider systems 104, one or more databases 106, and a network 108. The components and arrangement of the components included in system 100 may vary. Thus, system 100 may include other components that perform or assist in the performance of one or more operations consistent with the disclosed embodiments.

As more fully described below, user devices 102(1)-102(n) and service provider system 104 may include one or more computing devices (e.g., computer(s), server(s), etc.), memory storing data and/or software instructions (e.g., database(s), memory devices, etc.), and other known computing components. In some embodiments, the one or more computing devices may be configured to execute software instructions stored in the memory to perform one or more operations consistent with the disclosed embodiments. Aspects of service provider system(s) 104, database(s) 106, and user devices 102(1)-102(n) may be configured to communicate with one or more other components of system 100 via network 108, for example. In certain aspects, customers 114(1)-114(n) are respectively associated with and operate user devices 102(1)-102(n), to interact with one or more components of system 100 by sending and receiving communications, initiating operations, and/or providing input for one or more operations consistent with the disclosed embodiments. By way of example, customer 114(1) may be a sender participant and customer 114(2) may be a recipient participant. The sender participant may have a financial banking account (a “sender participant account”) with service provider system 104. The recipient participant may have a financial banking account (a “recipient participant account”) with service provider system 104. The sender participant is a customer that can initiate a request for a financial transfer to send a transfer amount (e.g., $1,000) from the sender participant account to the recipient participant account, by sending a financial transfer initiation request to service provider system 104 via network 108.

Service provider system 104 may be configured to access from database 106, customer account profiles for customer 114(1) associated with user device 102(1). A machine learning algorithm utilized by service provider system 104 may include a Gaussian Process Regression (GPR), or a convolution long short-term memory (LS™) network, however any other type of intelligence and machine learning model may be applied. The machine learning algorithm analyzes a customer account profile associated with customer 114(1) to identify customer account profiles associated with one or more of the second customers 114(2), . . . , 114(n) that are associated with first customer 114(1). The customer account profile includes customer financial transaction history, email history, or text messages associated with a sender participant. In this example, service provider system 104 identifies customer account profiles associated with customer 114(2) and customer 114(n) to be associated with customer 114(1). By way of example, the customer financial transaction history associated with customer 114(1) may include money transfer transactions or financial transactions between customer 114(1) and customer 114(2). As another example, the email history associated with customer 114(1) may include message communications in a context of exchanging money between customer 114(1) and customer 114(n). As a further example, the text messages communicated by customer 114(1) may include message communications in a context of exchanging money between customer 114(1) and customer 114(2). The machine learning algorithm analyzes the customer financial transaction history associated with customer 114(1) to identify customer account profiles associated customer 114(2) and customer 114(n) to be associated with customer 114(1). Further, the machine learning algorithm further analyzes the customer account profiles associated with customer 114(2) and customer 114(n) to determine the number of transactions, number of email communications, and number of text message communications performed between customer 114(2) and customer 114(1), and between customer 114(n) and customer 114(1). The machine learning algorithm ranks and displays the customer account profiles associated with customer 114(2) and customer 114(n), based on determinations of the number of transactions, number of email communications, and number of text message communications performed between customer 114(2) and customer 114(1), and between customer 114(n) and customer 114(1). If, for example, customer 114(2) has a higher number of number of transactions, number of email communications, and number of text message communications performed with customer 114(1) in comparison to the number of transactions, number of email communications, and number of text message communications performed by customer 114(n) with customer 114(1), then the customer account profile associated with customer 114(2) is given a highest rank of rank 1 while the customer account profile associated with customer 114(n) is given a rank of rank 2.

In some embodiments, service provider system 104 may be configured to receive a financial transfer initiation request from user device 102(1). More particularly, first customer 114(1) may utilize a user interface displayed on user device 102(1) to initiate a financial transfer request by accessing a financial banking mobile application stored on user device 102(1). For example, customer 114(1), may select an icon on a displayed banking mobile application, causing a financial transfer initiation request to be generated.

A recommendation model, communicatively coupled to or included within service provider system 104, is constructed in advance using training data. The training data includes customer account profile information associated with a plurality of customers stored in database 106. Service provider system 104 may use one or more of a machine learning process to construct the recommendation model to rank customer account profiles associated customers 114(1)-114(n). Service provider system 104 may also have a machine learning algorithm incorporated such that the recommendation model may be updated each time customer 114(1) selects a customer profile account from the list of ranked customer profile accounts. The customer account profile information is used to iteratively train and update the recommendation model to recommend ranked customer account profiles to first customer 114(1).

Database 106 of system 100 may be communicatively coupled to service provider system 104 and user devices 102(1)-102(n) via network 108. Database 106 may include one or more memory devices that store information and are accessed and/or managed by one or more components of system 100. By way of example, database 110 may include Oracle™ databases, Sybase™ databases, or other relational databases or nonrelational databases, such as Hadoop sequence files, HBase, or Cassandra. Database 106 may include computing components (e.g., database management system, database server, etc.) configured to receive and process requests for data stored in memory devices of database 106 and to provide data from database 106.

Database 106 is configured to store customer account profile data. The customer account profile data includes customer financial transaction history, email history, or text messages associated with a sender participant. By way of example, the customer financial transaction history may include money transfer transactions between customers. The email history may include message communications in a context of exchanging money between customers. The text messages may include message communications in a context of exchanging money between customers.

Service provider system 104 may be associated with a financial service entity that provides, maintains, manages, or otherwise offers financial services. For example, the financial service entity may be a bank, credit card issuer, or any other type of financial service entity that generates, provides, manages, and/or maintains financial service accounts for one or more users. Financial service accounts may include, for example, credit card accounts, loan accounts, checking accounts, savings accounts, reward or loyalty program accounts, and/or any other type of financial service account known to those skilled in the art. In providing, maintaining, managing or otherwise offering financial services, service provider system 104 may be enabled to authenticate financial transactions associated with financial service accounts of customers 114(1)-114(n).

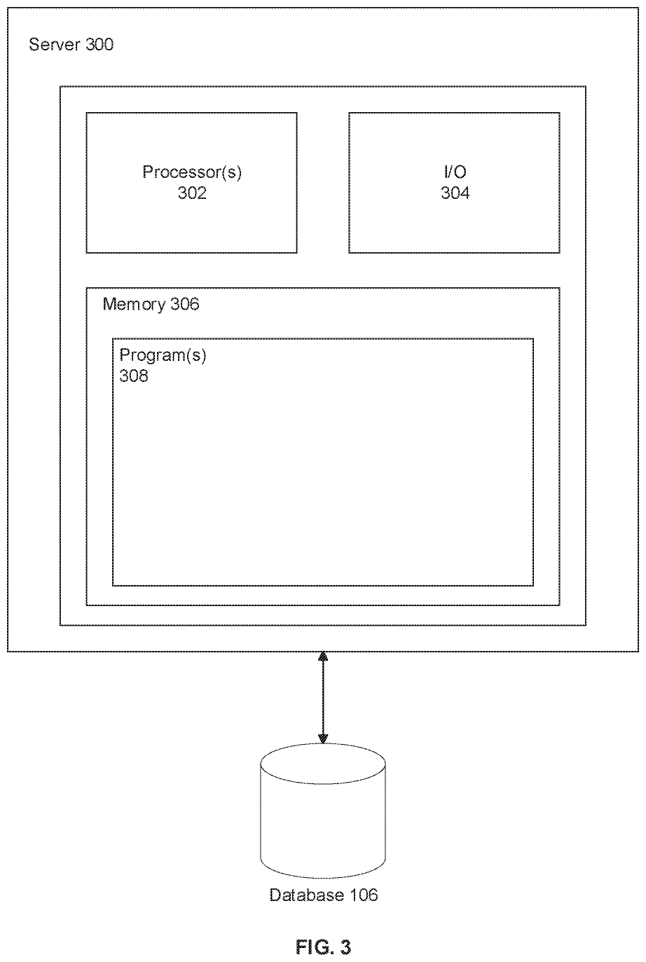

In one aspect, service provider system 104 may include one or more computing devices, configured to perform one or more operations consistent with disclosed embodiments, as described more fully below in relation to FIG. 3. In one aspect, service provider system 104 may include one or more servers or server systems. Service provider system 104 may include one or more processors configured to execute software instructions stored in a memory or other storage device. The one or more processors may be configured to execute the stored software instructions to perform internet-related communication, financial service-based processes, and machine learning for recommending ranked customer account profiles. The one or more computing devices of service provider system 104 may also be configured to communicate with other components of system 100 to recommend ranked customer account profiles. In some embodiments, service provider system 104 may provide one or more mobile banking applications, web-sites or online portals that are accessible by user devices 102(1)-102(n) over network 108. The disclosed embodiments are not limited to any particular configuration of service provider system 104.

Service provider system 104 and user devices 102(1)-102(n) may be configured to communicate with each other over network 108. Network 108 may comprise any type of computer networking arrangement configured to provide communications or exchange data, or both, between components of system 100. For example, network 108 may include any type of network (including infrastructure) that provides communications, exchanges information, and/or facilitates the exchange of information, such as the Internet, a private data network, a virtual private network using a public network, a LAN or WAN network, a Wi-Fi™ network, and/or other suitable connections that may enable information exchange among various components of system 100. Network 108 may also include a public switched telephone network (“PSTN”) and/or a wireless cellular network. Network 108 may be a secured network or unsecured network. In some embodiments, one or more components of system 100 may communicate directly through a dedicated communication link(s).

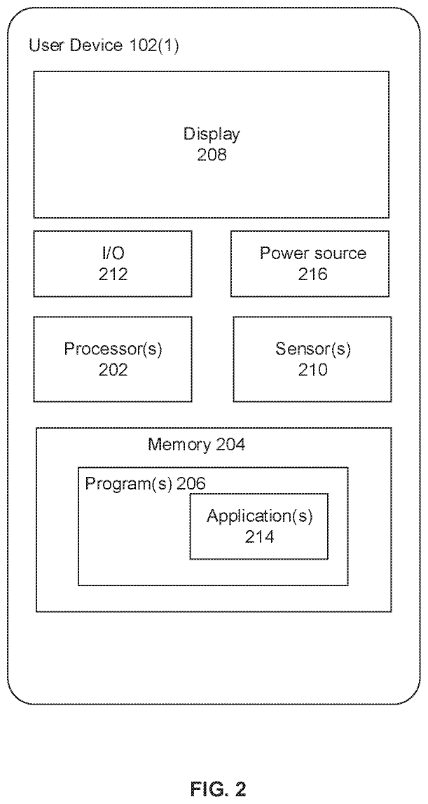

User devices 102(1)-102(n) may be one or more computing devices configured to perform one or more operations consistent with the disclosed embodiments, as described more fully below in relation to FIG. 2. User devices 102(1)-102(n) may execute browser or related mobile display software that displays ranked customer account profiles and interfaces for financial transactions, on a display included in, or connected to, user devices 102(1)-102(n). User devices 102(1)-102(n) may also store and execute other mobile applications that allow customers 114(1)-114(n) to select a method by which customers 114(1)-114(n) wish to receive notifications from service provider system 104.

It is to be understood that the configuration of the functional blocks of system 100 has been defined herein for convenience of description. The components and arrangement of the components included in system 100 may vary. For example, in some embodiments, system 100 may include other components that perform or assist in the performance of one or more processes consistent with disclosed methods. System 100 includes a number of components generally described as computing devices. Each of the computing devices may include any number of computing components particularly configured as a special purpose computing device to perform the functionality disclosed herein. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 2 is a block diagram of an exemplary user device 102(1), consistent with disclosed embodiments. User devices 102(2)-102(n) may be similarly configured.

User device 102(1) may enable associated customer 114(1) to perform remote interactions or mobile financial transactions with service provider system 104, for example, or receive information from service provider system 104. In some embodiments, user device 102(1) may be a personal computing device. For example, user device 102(1) may be a smartphone, a laptop or notebook computer, a tablet, a multifunctional watch, a pair of multifunctional glasses, or any mobile or wearable device with computing ability, or any combination of these computers and/or affiliated components.

User device 102(1) includes one or more processors 202 configured to execute software instructions stored in memory, such as a memory 204. Memory 204 may store one or more software programs 206 that when executed by processor 202 perform known Internet-related communication, content display processes, and other interactive processes for customer 114(1). For instance, user device 102(1) may execute a browser or related mobile display software that generates and displays interfaces including content on a display device 208 included in, or in communication with, user device 102(1). User device 102(1) may be a mobile device that executes mobile device applications and/or mobile device communication software, included in programs 206, that allows user device 102(1) to communicate with service provider system 104 and other components via network 108, to generate and display content in interfaces via display device 208. The disclosed embodiments are not limited to any particular configuration of user device 102(1). User device 102(1) may include any arrangement of one or more computing devices configured to perform one or more operations consistent with disclosed embodiments.

User device 102(1) may be configured to store, in memory 204, one or more operating systems that perform known operating system functions when executed by processor 202. By way of example, the operating systems may include Microsoft Windows™, Unix™, Linux™, Android™, Apple™ Mac OS operating systems, iOS, Chrome OS, or other types of operating systems. Accordingly, disclosed embodiments may operate and function with computer systems running any type of operating system. User device 102(1) may also include communication software stored in memory 204 that, when executed by processor 202, provides communications via network 108, such as Web browser software, tablet or smart handheld device networking software, etc.

Display device 208 may include, for example, a liquid crystal display (LCD), a light emitting diode screen (LED), an organic light emitting diode screen (OLED), a touch screen, and other known display devices. Display device 208 may display various information to customer 114(1). For example, display device 208 may display an interactive interface to customer 114(1) enabling customer 114(1) to operate user devices 102(1) to perform certain aspects of the disclosed methods. Display device 208 may display touchable or selectable options for customer 114(1) to select and may receive customer selection of options through a touch screen.

User device 102(1) includes I/O devices 212 that allow user device 102(1) to send and receive information or interact with customer 114(1) or another device. For example, I/O devices 212 may include various input/output devices, such as a keyboard, a mouse-type device, a gesture sensor, an action sensor, a physical button, switch, microphone, touchscreen panel, stylus, etc., that may be manipulated by customer 114(1) to input information using user devices 102(1). I/O devices 212 may also include an audio output device, such as a speaker configured to provide sound and audio feedback to customer 114(1) operating user device 102(1). In some embodiments, I/O devices 212 may include a light emitting component, such as an LED or other component capable of providing a visible signal to customer 114(1). I/O devices 212 may also include haptic output devices, to provide haptic feedback to customer 114(1). I/O devices 212 may also include one or more communication modules (not shown) for sending and receiving information from other components of system 100 by, for example, establishing wired or wireless connectivity between user device 102(1) and network 108. I/O devices 212 may include radio frequency, infrared, or other near-field communication interfaces, for communicating with other devices associated with network 108 or customer 114(1). Exemplary communication modules of I/O devices 212 may include, for example, a short-range or near field wireless communication modem, a Wi-Fi™ communication modem, or a cellular communication modem. I/O devices 212 may include a transceiver or transmitter configured to communicate using one or more wireless technologies/protocols that may include, without limitation, cellular (e.g., 3G, 4G, etc.) technology, Wi-Fi™ hotspot technology, RFID, near-field communication (NFC) or BLUETOOTH® technologies, etc. More generally, any uni- or bi-directional communication technology known to one of ordinary skill in the art may be implemented in user device 102(1) to exchange information with service provider system 104 or database 106 via network 108.

As described above, user devices 102(1) may be a device that executes mobile applications for performing operations consistent with disclosed embodiments. Thus, in some embodiments, programs 206 stored on user device 102(1) may include one or more software applications 214 installed thereon, that enable user device 102(1) to communicate with service provider system 104 via network 108 and perform aspects of the disclosed methods. For example, user device 102(1) may connect to service provider system 104 by using browser software to access and receive information or perform other operations associated with an internet service provider.

According to an exemplary embodiment, software applications 214 associated with service provider system 104 may be installed on user device 102(1), as shown in FIG. 2. For example, service provider system 104 may receive a request from user device 102(1) to download one or more software applications 214 to user device 102(1). In one embodiment, service provider system 104 may receive the request from customer 114(1), using a web browser application installed on user device 102(1). In another embodiment, service provider system 104 may receive the request to download one or more software applications 214 associated with service provider system 104 onto user device 102(1) from a webpage or another portal associated with service provider system 104 accessed by customer 114(1) via, e.g., user device 102(1). In this embodiment, service provider system 104 may store software instructions corresponding to one or more software applications 214 in database 106. For responding to the download request, service provider system 104 may receive additional information from user device 102(1) regarding the particular device specifications of user device 102(1) to enable user device 102(1) to download software instructions corresponding to the particular specifications. Alternatively, service provider system 104 may push a download request link to user device 102(1) or transmit software code corresponding to one or more software applications 214 directly to user device 102(1) in, for example, an e-mail, a text or short message service (SMS) message, a prompt through an app, or other suitable method. User device 102(1) may receive the software code related to one or more software applications 214, such as via network 108, to download and install the software code. Further, FIG. 2 shows a power source 216. The power source 216 is utilized to turn on and turn off the user device 102(1).

FIG. 3 shows an exemplary server 300 consistent with the disclosed embodiments. Variations of exemplary server 300 may constitute one or more components of service provider system 104. In one embodiment, server 300 includes one or more processors 302, one or more input/output (I/O) devices 304, and one or more memories 306. In some embodiments, server 300 may be a part of service provider system 104. In some embodiments, server 300 may take the form of a specially programmed server or computing system used by service provider system 104. In some embodiments, server 300 may be configured as an apparatus, embedded system, dedicated circuit, or the like based on the storage, execution, and/or implementation of software instructions that perform one or more operations consistent with the disclosed embodiments.

Processor 302 may include one or more known processing devices, such as a microprocessor from the Pentium™ or Xeon™ family manufactured by Intel™, or the Turion™ family manufactured by AMD™, for example. The disclosed embodiments are not limited to any type of processor(s) otherwise configured to meet the computing demands required of different components of system 100.

Input/output (I/O) devices 304 may include various input/output devices, such as a keyboard, a mouse-type device, a physical button, switch, etc., that may be manipulated by customers 114(1)-114(n) to input information using user devices 102(1)-102(n). I/O devices 304 may also include an audio output device. Exemplary communication modules of I/O devices 304 may include, for example, a short-range or near field wireless communication modem, a Wi-Fi™ communication modem, or a cellular communication modem. I/O devices 304 may include a transceiver or transmitter configured to communicate using one or more wireless technologies/protocols that may include, without limitation, cellular (e.g., 3G, 4G, etc.) technology, Wi-Fi™ hotspot technology, RFID, near-field communication (NFC) or BLUETOOTH® technologies, etc. More generally, any uni- or bi-directional communication technology known to one of ordinary skill in the art may be implemented in service provider system 104, user devices 102(1)-102(n) or database 106 via network 108.

Memory 306 may include one or more storage devices configured to store instructions used by processor 302 to perform functions related to disclosed embodiments. For example, memory 306 may be configured with one or more software instructions, such as program(s) 308 that perform one or more operations when executed by processor 302. The disclosed embodiments are not limited to separate programs or computers configured to perform dedicated tasks. For example, memory 306 may include a single program 308 that performs the functions of server 300, or program 308 may comprise multiple programs. In certain embodiments, memory 306 may store sets of instructions or programs 308 for determining a location of one or more of customers 114(1), . . . , 114(n), accessing customer parameter values, analyzing customer profiles and transmitting recommendations. These sets of instructions may be executed by processor 302 to perform communication and/or processes consistent with disclosed embodiments.

In certain embodiments, when server 300 constitutes one or more of the components of service provider system 104, memory 306 includes a recommendation model 312, corresponding to the above-described recommendation model, which uses a machine learning algorithm to identify and rank a set of second customers 114(2) . . . 114(n) that have customer account profiles that are associated with the customer account profile corresponding to first customer 114(1), as described in detail below. Recommendation model 312 may employ various machine learning algorithms including decision tree learning, association rule learning, artificial neural networks, inductive logic programming, support vector machines, clustering, Bayesian networking, reinforcement learning, representation learning, similarity and metric learning, spare dictionary learning, rule-based machine learning, etc. Recommendation model 312 may iteratively update its algorithm each time customers 114(1)-114(n) make a financial transaction, to increase its recommendation accuracy.

When service provider system 104 operates as server 300, server 300 monitors to determine if a financial transfer initiation request for financial transfer is received from user device 102(1). The financial transfer initiation request is a request to transfer monetary funds.

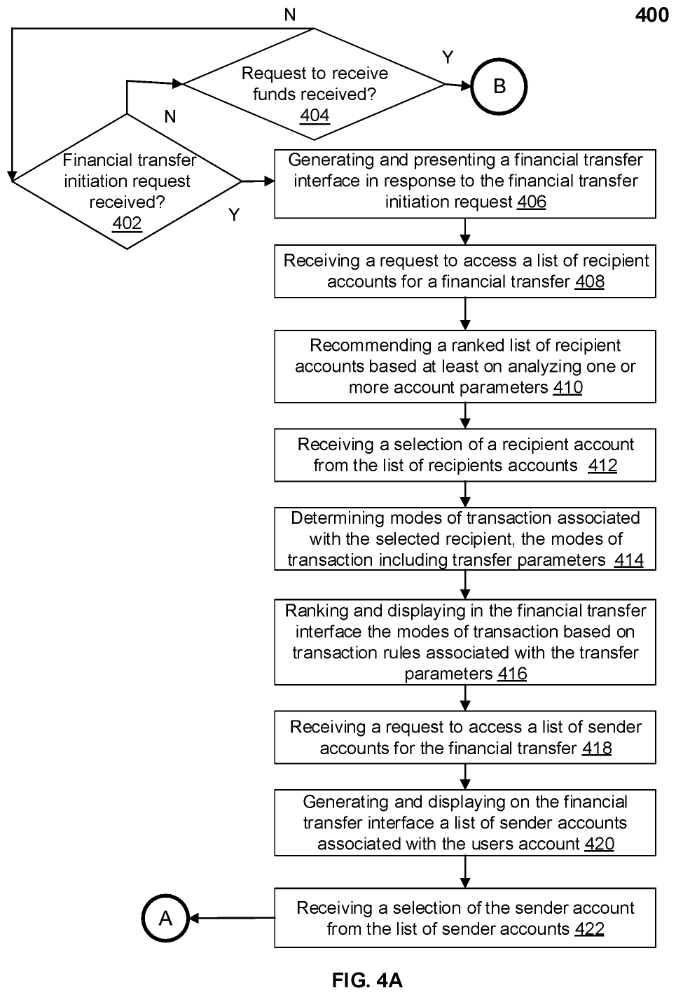

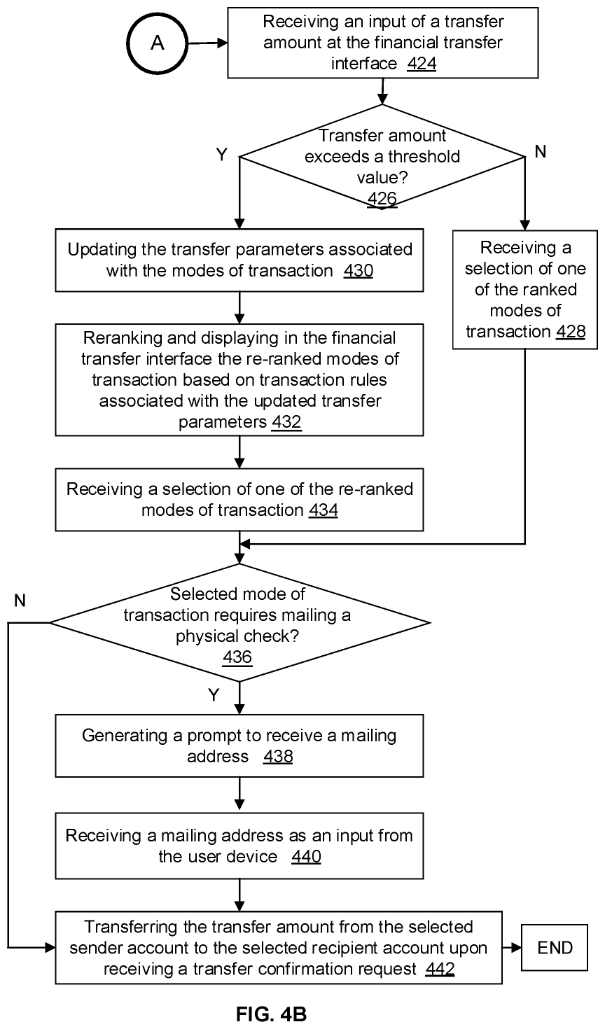

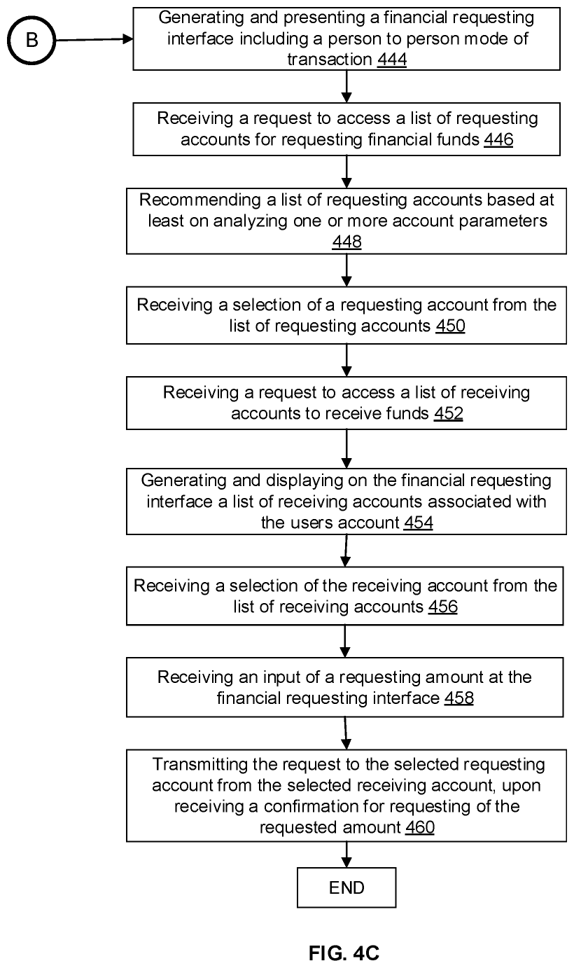

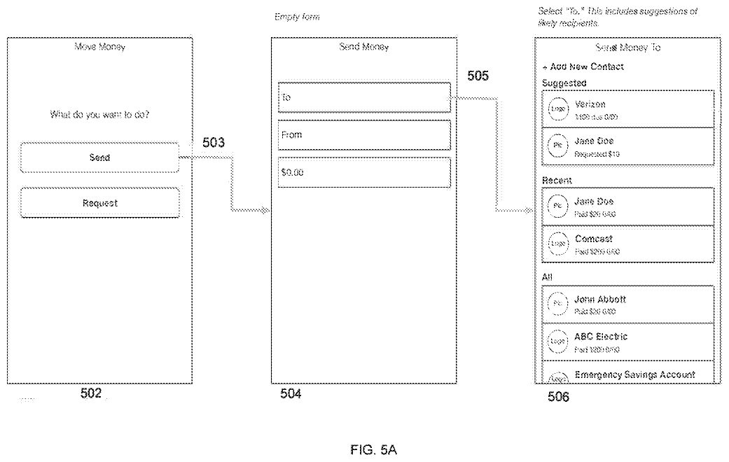

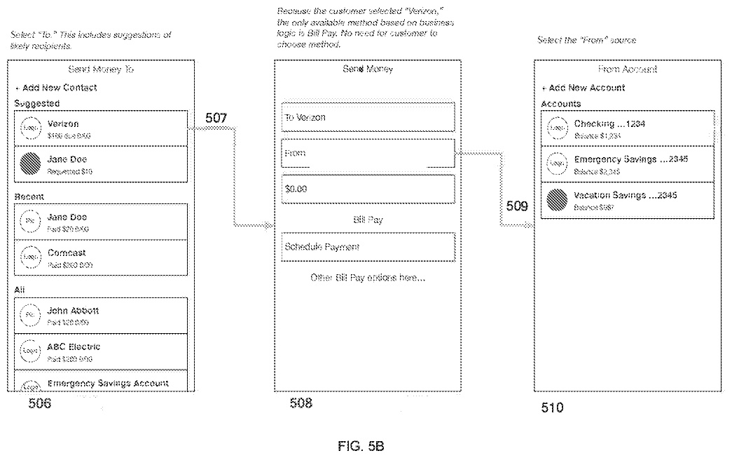

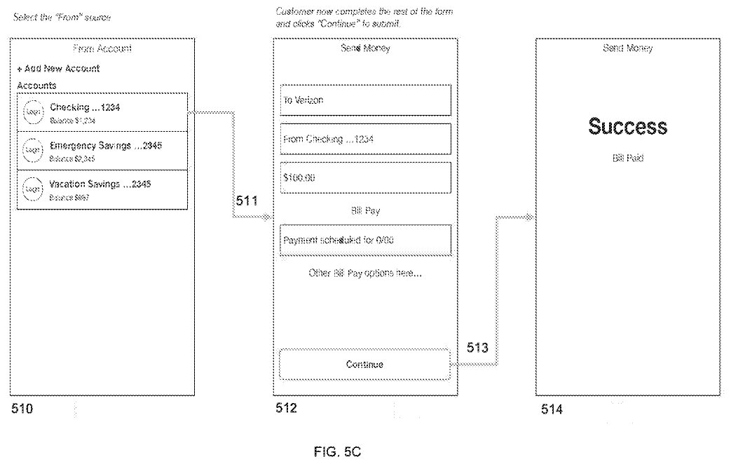

When server 300 determines that a financial transfer initiation request is received, then server 300 proceeds to generate and display on user device 102(1) a financial transfer interface in response to receiving the financial transfer initiation request. By way of example, first customer 114(1) utilizes a user interface displayed on user device 102(1) to initiate the financial transfer request by accessing a financial banking mobile application stored on user device 102(1). FIGS. 5A-5C contain screenshots. FIG. 5A shows an interface 502 that displays a financial banking mobile application with a “Send” icon and a “Request” icon. Upon customer 114(1) selecting the “Send” icon as shown by an arrow 503, the financial transfer initiation request is generated and a financial transfer interface 504 is displayed. Requesting to initiate a financial transfer by accessing a financial banking mobile application is explained in detail below with reference to an exemplary process 400, illustrated in FIG. 4A-4C, for automatically determining a mode of financial transaction.

Prior to describing process 400, brief descriptions of exemplary user interfaces for determining modes of financial transactions, in FIGS. 5A-5C, 6A-6C, 7A-7C, and 8A-8C, are provided.

FIGS. 5A-5C contain exemplary interfaces of exemplary process 400 with regard to automatically determining a bill payment mode of financial transaction based on account identifiers associated with participants of the financial transaction, consistent with disclosed embodiments. FIG. 5A shows Interface 502 labelled “Move Money” in which customer 114(1) can select the “Send” icon to generate the financial transfer initiation request. In response to the financial transfer initiation request, server 300 generates interface 504 labelled “Send Money”. Customer 114(1) selects a “To” icon to generate interface 506 labelled “Send Money To”. Interface 506 provides a recommendation of a ranked list of recipient accounts. FIG. 5B shows in interface 506 that customer 114(1) selects Verizon as the recipient of the transfer, as shown by arrow 507. Upon the selection of Verizon, server 300 generates interface 508. Server 300 determines that the selected recipient Verizon is a commercial entity based on accessing a lookup table stored in database 106. The determination is made based on determining a type associated with the selected recipient account by accessing a previously stored lookup table in database 106. The lookup table stores one or more modes of transaction associated with each type of recipient account. By way of example, the lookup table may store the recipient account type of a commercial entity (e.g. Comcast services, Verizon services, AT&T, ABC Electric, etc), to be associated with only one mode of transaction, i.e., a Bill Pay mode of transaction, such that all commercial entities may be associated with a Bill Pay mode of transaction, as shown in an interface 508 of FIG. 5B. The lookup table includes for a recipient account type of an individual account holder, then the mode of transaction associated with the individual account holder can include: Person to Person (P2P) transfer mode of transaction, Mail a Check mode of transaction, and Cashier's Check mode of transaction. Also, the lookup table further includes for a requesting account type of an individual account holder, a P2P mode of transaction to request money from a requesting account is included, although any other modes of transaction may also be included._Upon the selection of Verizon, server 300 generates interface 508. As server 300 determines that the selected recipient Verizon is a commercial entity based on accessing the lookup table stored at database 106, the mode of transaction is determined to be a Bill Pay mode of transaction. As a result, server 300 displays the Bill Pay mode of transaction in interface 508. Then, customer 114(1) selects a “From” icon in interface 508, which results in generating interface 510 labeled “From Account”, as shown by arrow 509. Interface 510 is utilized to prompt customer 114(1) to select the account from which customer 114(1) would like to make the bill payment to the recipient Verizon. Customer 114(1) makes a selection of a “Checking 1234” account as the “From” account, as shown in interface 510 of FIG. 5C. Upon the selection of the “Checking 1234” account, in interface 510, customer 114(1) inputs the transfer amount of $100 to schedule payment of the bill at Verizon, as shown by arrow 511. Customer 114(1) then selects the “Continue” icon to provide a transfer confirmation request, which results completing the payment of the bill of $100 from the customer “Checking account 1234” to the account associated with “Verizon”, as shown by arrow 513.

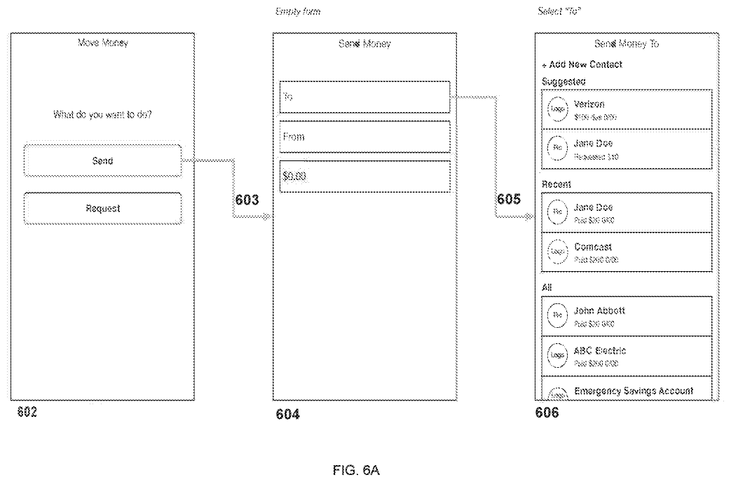

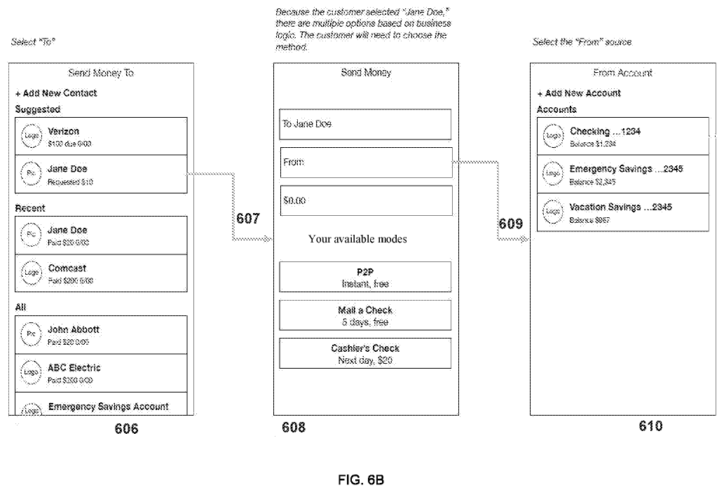

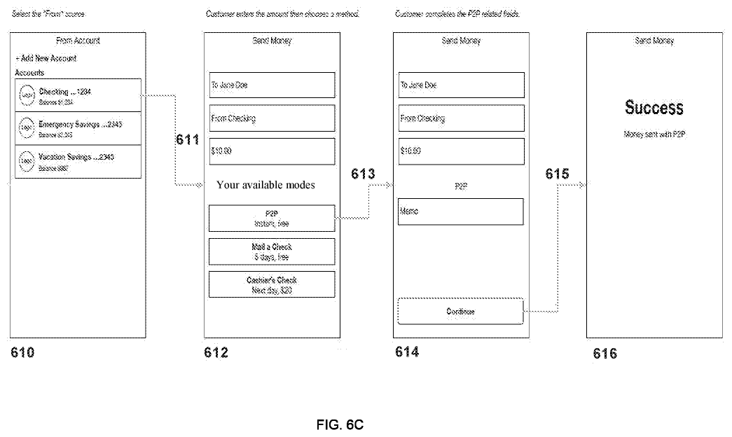

FIGS. 6A-6C contain exemplary interfaces of exemplary process 400 with regard to automatically determining multiple modes of money transfer based on account identifiers associated with participants of the financial transaction, consistent with disclosed embodiments. FIG. 6A shows an interface 602 labelled “Move Money” in which customer 114(1) can select a “Send” icon to generate a financial transfer initiation request, as shown by arrow 603. In response to the financial transfer initiation request, server 300 generates an interface 604 labelled “Send Money”. Customer 114(1) selects a “To” icon to generate an interface 606 labelled “Send Money To”, as shown by arrow 605. Interface 606 provides a recommendation of a ranked list of recipient accounts. FIG. 6B shows in an interface 606 that customer 114(1) selects Jane Doe as the recipient of the transfer, as shown by arrow 607. Upon the selection of Jane Doe, server 300 generates an interface 608. As server 300 determines that the selected recipient Jane Doe is an individual account holder based on accessing a lookup table stored in database 106 (as explained above), the mode of transaction is determined to include the P2P mode of transaction, the Mail a Check mode of transaction, or the Cashier's Check mode of transaction. Further, server 300 ranks the modes of transaction based on transfer parameters associated with each of the modes of transaction. As a result, server 300 displays the three modes of transaction in interface 608 in the ranked order. Then, customer 114(1) selects a “From” icon in interface 608 which results in generating an interface 610 labeled “From Account”, as shown by arrow 609. Interface 610 is utilized to prompt customer 114(1) to select the account from which customer 114(1) would like to send money to Jane Doe, as shown by arrow 611. Customer 114(1) selects of the “Checking 1234” account as the “From” account, as shown in interface 610 of FIG. 6C. Upon the selection, in interface 610, customer 114(1) inputs a transfer amount of $10 to transfer to Jane Doe. Customer 114(1) subsequently selects a “Continue” icon to provide transfer confirmation request, as shown in interface 614, which results in completing the transfer of $10 from “Checking account 1234” to the account associated with “Jane Doe”.

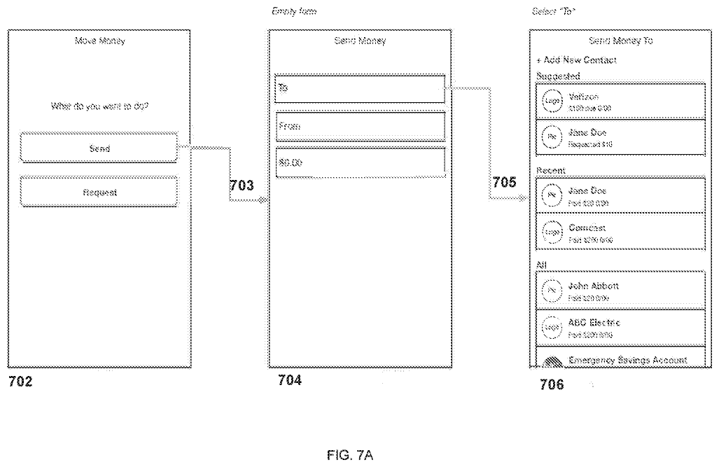

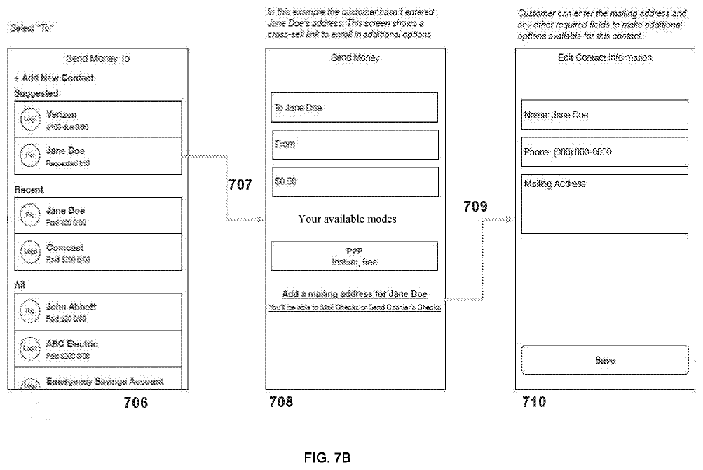

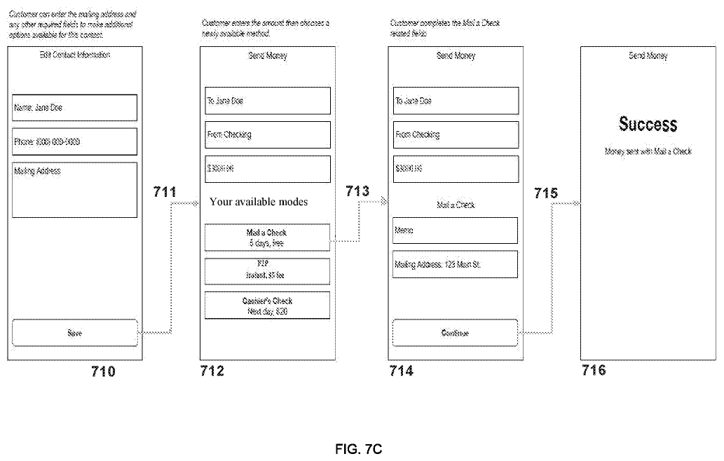

FIGS. 7A-7C contain exemplary interfaces of exemplary process 400 with regard to adding a mailing address for a money transfer and automatically determining multiple modes of money transfer based on account identifiers associated with participants of the financial transaction, consistent with disclosed embodiments. FIG. 7A shows an interface 702 labelled “Move Money” in which customer 114(1) can select a “Send” icon to generate a financial transfer initiation request, as shown by arrow 703. In response to the financial transfer initiation request, server 300 generates an interface 704 labelled “Send Money”. Customer 114(1) selects a “To” icon to generate interface 706 labelled “Send Money To”, as shown by arrow 705. Interface 706 provides a recommendation of a ranked list of recipient accounts. FIG. 7B shows in interface 706 customer 114(1) selects Jane Doe as the recipient of the transfer, as shown by arrow 707. Upon the selection of Jane Doe, server 300 generates interface 708 labelled “Send Money”. As server 300 determines that the selected recipient Jane Doe is an individual account holder based on accessing the lookup table stored at database 106 (as explained above), the mode of transaction is determined to include the P2P mode of transaction, the Mail a Check mode of transaction, and the Cashier's Check mode of transaction. Server 300 then determines that customer 114(1) does not have a mailing address associated with mailing of a Check to Jane Doe stored in the database 106. As a result, server 300 displays a prompt asking customer 114(1) to input the mailing address for Jane Doe, as shown in interface 708. With reference to FIG. 7C, upon customer 114(1) selecting the prompt, an interface 710 is generated and customer 114(1) inputs recipient Jane Doe's mailing address, as shown by arrow 711. Then, customer 114(1) selects a “From” icon from interface 714 and customer 114(1) makes a selection of the “Checking 1234” account as the “From” account (not shown here). Upon the selection, in an interface 712, customer 114(1) inputs a transfer amount of $3000 to transfer to Jane Doe. In interface 712, upon entering the transfer amount, server 300 ranks the modes of transaction based on transfer parameters associated with each of the modes of transaction. As a result, server 300 displays the three modes of transaction in interface 712 in the ranked order. Customer 114(1) then selects a “Continue” icon in an interface 714 to provide transfer confirmation request, which results in completing the transfer of $3000 from the customers “Checking account 1234” to the account associated with “Jane Doe”. In this example, as the transfer amount $3000 exceeds a threshold value of $2500, the transfer parameters associated with the modes of transaction in interface 712 are different in comparison to the transfer parameters associated with the modes of transaction in interface 612. As a result the ranking orders of the modes of transaction are also different.

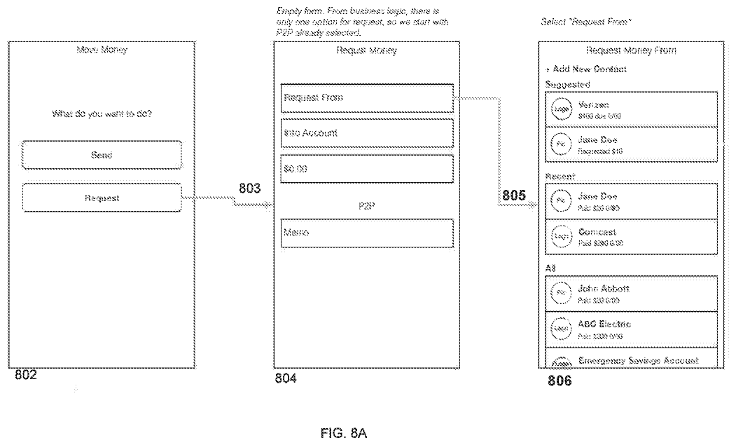

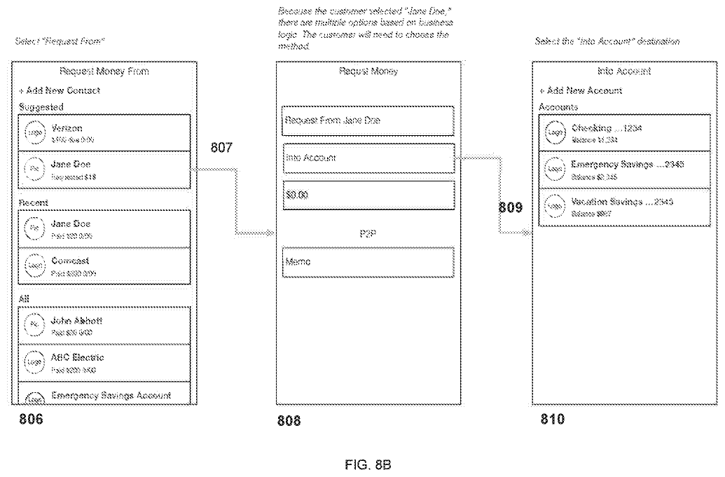

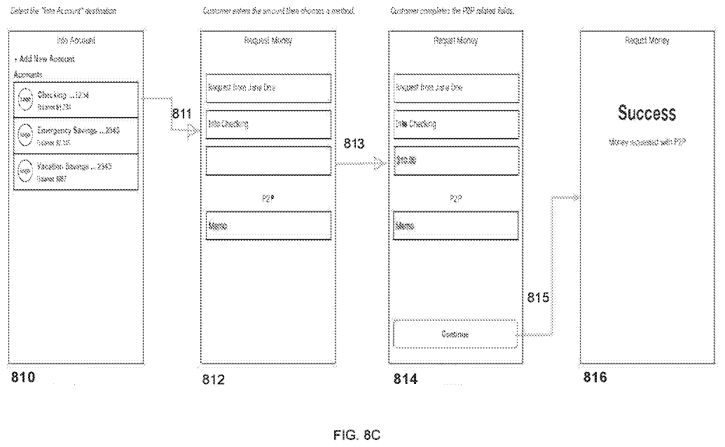

FIGS. 8A-8C contain exemplary interfaces of exemplary process 400 regarding automatically determining a mode of requesting money transfer based on account identifiers associated with participants of the financial transaction, consistent with disclosed embodiments. FIG. 8A shows an interface 802 labelled “Move Money” in which customer 114(1) can select a “From” icon to generate a request to receive funds, as shown by arrow 803. In response to the request to receive funds, server 300 generates an interface 804 labelled “Request Money”, as shown by arrow 805. Customer 114(1) selects the “Request From” icon to generate interface 806 labelled “Request Money From”. Interface 806 provides a recommendation of a ranked list of requesting accounts. FIG. 8B shows in interface 806 that customer 114(1) selects Jane Doe as the sender of the transfer, as shown by arrow 807. Upon the selection of Jane Doe, server 300 generates an interface 808. As server 300 determines that the selected sender Jane Doe is an individual account holder, server 300 determines that a money transfer can only be requested via the P2P mode of transaction, thus the mode of transaction is determined to include P2P mode of transaction. Then, customer 114(1) selects the “Into Account” icon from interface 808 which results in generating an interface 810 labeled “Into Account”, as shown by arrow 809. Interface 810 is utilized to prompt customer 114(1) to select the account into which customer 114(1) would like to receive the funds from Jane Doe. Customer 114(1) selects “Checking 1234” account as the “Into Account” account as shown in interface 810 of FIG. 8C. Upon the selection, in interface 810, customer 114(1) inputs the transfer amount of $10 to transfer from Jane Doe. The customer 114(1) then selects the “Continue” icon to provide transfer confirmation request, which results in requesting an account associated with “Jane Doe” to the transfer $10 into the customer “Checking account 1234”.

Server 300 monitors to determine if a request to access a list of recipient accounts has been received. FIG. 5A shows the financial transfer interface 504 including a “To” and a “From” icon. Server 300 receives the request to access a list of recipient accounts when customer 114(1) selects the “To” icon as shown by the arrow 505. Upon receiving the request to access a list of recipient accounts, server 300 recommends a list of recipient accounts based at least on analyzing one or more account parameters. The account parameters include user transaction history. The machine learning algorithm accesses the customer account profile associated with customer 114(1) stored in database 106. The machine learning algorithm analyzes the customer account profile associated first customer 114(1) to identify customer account profiles associated with recipients accounts corresponding to one or more of second customers 114(2) . . . 114(n) that are associated with the customer 114(1). The customer account profile includes customer financial transaction history, email history, or text messages associated with a sender participant. FIG. 5A shows three lists of customer account profiles in the user interface 506.

The three lists of customer account profiles in FIG. 5A include a list of suggested recipient accounts, a list of recent recipient accounts, and a list of all the recipient accounts. The list of suggested recipient accounts is recommended and generated based on analyzing the email history and/or text messages associated with customer 114(1) to determine a bill payment due date associated with, for example, a Verizon account and a request for money transfer received from Jane Doe. In another example, the machine learning algorithm ranks the list of suggested recipient accounts based on a time period associated with the accounts, In this example, a bill payment due date associated with the Verizon account is given a rank 1 in comparison to a request of money transfer to a Jane Doe account, as the due date associated with Verizon account is closer in comparison to the money transfer due date associated with the Jane Doe account. In the ranked list of recipients accounts, in this example, Verizon is given the highest rank of rank 1 while Jane Doe is given a rank 2, based on analyzing customer account profiles associated Verizon and Jane Doe. The list of recent recipient accounts is recommended and generated based on analyzing the financial transaction history, email history, and/or text messages associated with customer 114(1) to determine a ranked list of recipient accounts based on when customer 114(1) last communicated with the recipient accounts. By way of example, the machine learning algorithm determines that customer 114(1) had last interacted or communicated with the Jane Doe recipient account based on analyzing the financial transaction history, email history and/or text messages associated with customer 114(1). Thus, the list of recent recipient accounts displayed on interface 506 shows the Jane Doe recipient account ranked higher in comparison to the Comcast recipient account, as customer 114(1) had last interacted with the Jane Doe recipient account. The list of all the recipient accounts displays all the recipient accounts associated with the customer 114(1) ranked either alphabetically or chronologically.

Server 300 monitors to determine if a selection of a recipient account from the list of recipient accounts has been received. FIG. 5B shows a financial transfer interface 506 in which customer 114(1) selects the Verizon recipient account from the list of recipient accounts, as shown by arrow 507. Upon receiving the selection of a recipient account, in this example the Verizon recipient account, server 300 determines a mode of transaction associated with the selected recipient. The determination is made based on determining a type associated with the selected recipient account by accessing a previously stored lookup table in database 106 (as explained above). Further, each of the modes of transaction s associated with transfer parameters. By way of example, the P2P transfer mode of transaction has transfer parameters of providing instant monetary transfers to recipient accounts and no transaction fees or free of charge transactions. The Mail a Check mode of transaction has transfer parameters of a time period of 5 days for monetary transfers to recipient accounts and no transaction fees or free of charge transactions. The Cashier's Check mode of transaction has transfer parameters of a time period of next day for monetary transfers to recipient accounts and with $20 transaction fee.

Upon determining modes of transactions associated with the selected recipients, server 300 assigns ranking to the identified modes of transaction and displays the ranked modes of transaction on the financial transfer interface. By way of example, when server 300 determines that the recipient account is an individual account holder, then server 300 determines that the modes of transaction associated with individual account holder include the P2P transfer mode of transaction, the Mail a Check mode of transaction, and the Cashier's Check mode of transaction. Server 300 accesses transaction rules stored in database 106 to rank the determined P2P transfer mode of transaction, Mail a Check mode of transaction, and Cashier's Check mode of transaction based on transfer parameters associated with the modes of transaction. The transaction rules may include assigning a highest ranking (i.e. rank 1) to the modes of transaction that provide no transaction fees or free of charge transactions, assigning a next lower rank (e.g. rank 2) to the mode of transaction that provides instant monetary transfers to recipient accounts, assigning a next lower rank (e.g. rank 3) to the modes of transaction that provide next day monetary transfers, assigning a next lower rank (e.g. rank 4) to the modes of transaction based on increasing order of time period required to complete monetary transfers, and assigning a next lower rank (e.g. rank 5) to the modes of transaction based on increasing order of transaction fees associated with the monetary transfers, although any combination and/or order of transaction rules may also be included. In this example, based on the transaction rules associated with the transaction parameters, server 300 assigns rank 1 to the P2P transfer mode of transaction, rank 2 to the Mail a Check mode of transaction, and rank 3 to the Cashier's Check mode of transaction, as displayed on interface 608 of FIG. 6B.

Then server 300 monitors to determine if a request to access a list of sender accounts for the financial transfer has been received. FIG. 5A shows the financial transfer interface 504 including a “To” and a “From” icon. Server 300 receives the request to access a list of sender accounts for the financial transfer when customer 114(1) selects the “From” icon, as shown at interface 608 in FIG. 6B, as shown by arrow 609. Upon receiving the request to access a list of sender accounts for the financial transfer, server 300 generates and displays a list of sender accounts for the financial transfer, as shown in interface 610 of FIG. 6B. The list of sender accounts includes one or more checking accounts and one or more savings accounts.

Server 300 then monitors to determine if a selection of the sender account from the list of sender accounts has been received. By way of example, server 300 receives a selection of a checking account from the user, as shown in interface 610 of FIG. 6C, and as shown by arrow 611. Upon selection of the checking account, interface 612 updates the “From” section to display the name of the selected account, e.g., “Checking”.

Server 300 then monitors to determine if an input of a transfer amount has been received from customer 114(1) via interface 612. By way of example, server 300 receives an input transfer amount of, for example, $10 from customer 114(1), although any other amount can also be included, as shown in interface 612 of FIG. 6C.

Upon receiving the transfer amount, server 300 determines if the transfer amount exceeds a threshold value. The threshold value may be pre-defined by service provider system 104. By way of example, the threshold value is $2,500, although any amount may be included. In this example, as the input transfer amount received in $10, server 300 determines that the transfer amount does not exceed the threshold value of $2,500, as shown in interface 612 of FIG. 6C, then server 300 proceeds to determine if a selection of one of the ranked modes of transaction is received.

However, in another example, as shown in interface 712 of FIG. 7C, server 300 receives an input transfer amount of, $3000 from customer 114(1). As the input transfer amount received is $3000, server 300 determines that the transfer amount does exceed the threshold value of $2500, as shown in interface 712 of FIG. 7C. Upon determining that the transfer amount does exceed the threshold value, server 300 updates the transfer parameters associated with the modes of transaction. For the transfer amount of $3000, the service provider system 104 may apply a transaction fee of, e.g., $5, per transaction for instant deposits as part of the P2P mode of transaction. As a result, a transfer parameter of the P2P mode of transaction is updated to provide instant monetary transfers to recipient accounts with a $5 transaction fees.

Upon updating the transfer parameters, server 300 re-ranks the modes of transactions based on stored transaction rules (as described above). Server 300 now assigns a rank 1 to the Mail a Check mode of transaction, rank 2 to the P2P mode of transaction, and rank 3 to the Cashier's Check mode of transaction, as displayed by the arrow 713 of FIG. 7C.

Server 300 then monitors to determine if a selection of one of the re-ranked modes of transaction is received from customer 114(1). By way of example, customer 114(1) may select the Mail a Check mode of transaction to proceed with the transaction, as shown in interface 712.

Upon receiving a selection of one of the re-ranked modes of transaction, server 300 determines if the selected mode of transaction requires mailing of a physical check. The modes of transaction that require mailing of a physical check include the Mail a Check mode of transaction and the Cashier's Check mode of transaction. When server 300 determines that the received selection of one of the re-ranked modes of transaction is the Mail a Check mode of transaction or the Cashier's Check mode of transaction, then server 300 proceeds to determine if a mailing address associated with the Check is previously stored in database 106. When server 300 determines that the mailing address associated with the Check is previously stored, as shown in interface 714 of FIG. 7C, the method proceeds to transferring the inputted transfer amount. However, when server 300 determines that the mailing address to mail the Check is not stored in database 106, then server 300 proceeds to generate a prompt to receive the mailing address from customer 114(1), as shown in interface 710. Upon receiving the mailing address from customer 114(1) via interface 710 of FIG. 7C, the method proceeds to transferring the inputted transfer amount.

In another example, referring again to step 414, server 300 determines the modes of transaction associated with the selected recipient includes the Mail a Check mode of transaction or the Cashier's Check mode of transaction, then server 300 determines if a mailing address associated with mailing of the Check is previously stored in database 106. When server 300 determines that the mailing address associated with the Check is previously stored, the method proceeds to ranking and displaying the modes of transaction.

When server 300 determines that a financial transfer initiation request is not received, then server 300 proceeds to determine if a request to receive funds has been received. When server 300 determines that a request to receive funds has been received, then server 300 proceeds to generate and display a financial requesting interface in response to receiving the request to receive funds. By way of example, first customer 114(1) utilizes a user interface displayed on user device 102(1) to initiate the request to receive funds by accessing a financial banking mobile application stored on user device 102(1). FIG. 8A shows interface 802 that displays the financial banking mobile application with a “Send” icon and a “Request” icon. Upon customer 114(1) selecting the “Request” icon as shown in interface 802, the request to receive funds is generated and financial requesting interface 804 including a P2P mode of transaction is displayed. As requesting to receive funds is performed between individual account holders, server 300 selects the P2P mode of transaction as the only mode of transaction. Requesting to receive funds by accessing a financial banking mobile application is further described below.

Exemplary process 400 for automatically determining a mode of financial transaction to utilize for a financial transaction based on account identifiers associated with participants of the financial transaction, consistent with the disclosed embodiments, is described next with reference to FIGS. 4A-4C. In certain aspects, service provider system 104 utilizes server 300 to execute software instructions that perform one or more of the operations of process 400. Also, server 300 may perform all of the functions of service provider system 104.

Service provider system 104 in step 402 of FIG. 4A monitors to determine if a financial transfer initiation request for financial transfer is received from user device 102-1. The financial transfer initiation request is a request to transfer monetary funds.

In step 402, if server 300 determines that a financial transfer initiation request is received, then server 300 takes the Yes branch and proceeds to step 406 to generate and display a financial transfer interface in response to receiving the financial transfer initiation request. By way of example, first customer 114(1) utilizes a user interface displayed on user device 102(1) to initiate the financial transfer request by accessing a financial banking mobile application stored on user device 102(1). FIG. 6A shows interface 602 that displays the financial banking mobile application with a “Send” icon and a “Request” icon. Upon customer 114(1) selecting the “Send” icon, the financial transfer initiation request is generated and the financial transfer interface 604 is displayed.

Next, in step 408, server 300 monitors to determine if a request to access a list of recipient accounts has been received. FIG. 6A shows financial transfer interface 604 including a “To” and a “From” icon. The “To” icon represents a banking account to which customer 114(1) would like to transfer funds. The “From” icon represents a banking account from which customer 114(1) would like to transfer funds to the banking account associated with “To” icon. Server 300 receives the request to access a list of recipient accounts when customer 114(1) selects the “To” icon.

In step 410, server 300 utilizes the machine learning algorithm to recommend a list of recipient accounts based at least on analyzing one or more account parameters, upon receiving the request to access a list of recipient accounts. The account parameters include user transaction history. The machine learning algorithm accesses the customer account profile associated with customer 114(1) stored in database 106. The machine learning algorithm analyzes the customer account profile associated with customer 114(1) to identify customer account profiles associated with recipient accounts corresponding to one or more of second customers 114(2) . . . 114(n) that are associated with customer 114(1). The customer account profile includes customer financial transaction history, email history, or text messages associated with a sender participant. FIG. 6A shows the three lists of recommended recipient accounts profiles in user interface 606, as previously described.

In step 412, server 300 monitors to determine if a selection of a recipient account identifier from the list of recipient accounts has been received. FIG. 6B shows the financial transfer interface in which customer 114(1) selects “Jane Doe” as the recipient account from the list of recipient accounts, in interface 608.

In step 414, server 300 determines a mode of transaction associated with the selected recipient. The determination is made based on determining a type associated with the selected recipient account by accessing a previously stored lookup table in database 106, upon receiving the selection of a recipient account which in this example is the Verizon recipient account. For each type of a recipient account the lookup table stores corresponding one or more modes of transaction associated with that type of recipient account. By way of example, when the recipient account type is a commercial entity (e.g. Comcast services, Verizon services, AT&T, ABC Electric, etc), then the mode of transaction associated with the commercial entity is only one mode of transaction, i.e., Bill Payment mode of transaction, as shown in interface 508 of FIG. 5B.

In this example, as the recipient account type is an individual account holder, i.e., “Jane Doe”, then the mode of transaction associated with the individual account holder includes: the Person to Person (P2P) transfer mode of transaction, the Mail a Check mode of transaction, the Cashier's Check mode of transaction, as shown in interface 608, although any other modes of transaction may also be included. Further, each of the modes of transactions are associated with transfer parameters. By way of example, the P2P transfer mode of transaction has transfer parameters of providing instant monetary transfers to recipient accounts and no transaction fees or free of charge transactions. The Mail a Check mode of transaction has transfer parameters of a time period of 5 days for monetary transfers to recipient accounts and no transaction fees or free of charge transactions. The Cashier's Check mode of transaction has transfer parameters of a time period of next day for monetary transfers to recipient accounts and a $20 transaction fees, as shown interface 608.

In step 416, server 300 assigns ranking to the identified modes of transaction and displays the ranked modes of transaction on the financial transfer interface, upon determining modes of transactions associated with the selected recipients. By way of example, when server 300 determines that the recipient account is an individual account holder, then server 300 determines that the modes of transaction associated with individual account holder include the P2P transfer mode of transaction, the Mail a Check mode of transaction, and the Cashier's Check mode of transaction. Server 300 accesses transaction rules stored in database 106 to rank the determined P2P transfer mode of transaction, the Mail a Check mode of transaction, and the Cashier's Check mode of transaction based on transfer parameters associated with the modes of transaction. In this example, based on the transaction rules associated with the transaction parameters, Server 300 assigns rank 1 to the P2P transfer mode of transaction, rank 2 to the Mail a Check mode of transaction and rank 3 to the Cashier's Check mode of transaction, as displayed on interface 608 of FIG. 6B.

In step 418, server 300 monitors to determine if a request to access a list of sender accounts for the financial transfer has been received. FIG. 6B shows financial transfer interface 608 including the “To” and the “From” icon. As explained above, the “From” icon represents a banking account from which customer 114(1) would like to transfer funds to the banking account associated with “To” icon. Server 300 receives the request to access a list of sender accounts for the financial transfer when customer 114(1) selects the “From” icon, as shown at interface 608 in FIG. 6B.

In step 420, server 300 generates and displays a list of sender accounts for the financial transfer, as shown in interface 610 of FIG. 6B, upon receiving the request to access a list of sender accounts for the financial transfer. The list of sender accounts includes a checking account and an Emergency savings account.

In step 422, server 300 monitors to determine if a selection of the sender account from the list of sender accounts has been received. By way of example, server 300 receives a selection of a checking account from the user, as shown by the arrow 611 in between interfaces 610 and 612 of FIG. 6C. Upon selection of the checking account, interface 612 updates the “From” section to display the name of the selected account, e.g., “Checking”.

In step 424, server 300 monitors to determine if an input of a transfer amount has been received from customer 114(1) via interface 612. By way of example, Server 300 receives an input transfer amount of, for example, $10 from customer 114(1), although any other amount can also be included, as shown in interface 612 of FIG. 6C.

In step 426, upon receiving the transfer amount, server 300 determines if the transfer amount exceeds a threshold value, as explained above. In this example, as the input transfer amount received in $10, server 300 determines that the transfer amount does not exceed the assumed threshold value of $2,500, shown in interface 612 of FIG. 6C. As a result, server 300 takes the No branch and proceeds to step 428 to determine if a selection of one of the ranked modes of transaction is received.

In step 426, server 300 receives an input transfer amount of, for example, $3000 from the customer 114(1), although any other amount can also be included, as shown in interface 712 of FIG. 7C. In this example, as the input transfer amount received is $3000, Server 300 determines that the transfer amount exceeds the threshold value of $2500, as shown in interface 712 of FIG. 7C. Upon determining that the transfer amount does exceed the threshold value, Server 300 takes the Yes branch of step 426 to step 430.

In step 430, server 300 updates the transfer parameters associated with the modes of transaction. For the transfer amount of $3000, service provider system 104 may apply a transaction fees of $5 per transaction for instant deposits as part of the P2P mode of transactions. As a result, the transfer parameter of the P2P mode of transaction is updated to provide instant monetary transfers to recipient accounts with a $5 transaction fees, as shown in interface 712 of FIG. 7C.

In step 432, server 300 re-ranks the modes of transactions based on stored transaction rules, upon updating the transfer parameters. The re-ranking of the modes of transaction is performed similar to step 416 as described above. In step 432, the re-ranking is performed based on the updated transfer parameters. Server 300 now assigns a rank 1 to the Mail a Check mode of transaction, the rank 2 to P2P mode of transaction, and rank 3 to the Cashier's Check mode of transaction, as displayed on interface 712 of FIG. 7C.

In step 434, server 300 monitors to determine if a selection of one of the re-ranked modes of transaction is received from customer 114(1). By way of example, customer 114(1) may select the Mail a Check mode of transaction to proceed with the transaction, as shown in interface 712.

In step 436, upon receiving a selection of one of the re-ranked modes of transaction, server 300 determines if the selected mode of transaction requires mailing of a physical check. The modes of transaction that require mailing of a physical check include the Mail a Check mode of transaction and the Cashier's Check mode of transaction. Server 300 makes a determination if the received selection of one of the re-ranked modes of transaction is the Mail a Check mode of transaction or the Cashier's Check mode of transaction. When server 300 determines that the received selection of one of the re-ranked modes of transaction is the Mail a Check mode of transaction or the Cashier's Check mode of transaction, then server 300 takes the Yes branch of step 436 and proceeds to step 438. In step 438, server 300 determine if a mailing address for the Check is previously stored in the database 106. When server 300 determines that the mailing address associated with the Check is previously stored as shown in interface 714 of FIG. 7C, the method proceeds to step 442 for transferring the inputted transfer amount. When, in step 438, server 300 determines that the mailing address to mail the Check is not stored in the database 106, then server 300 proceeds to generate a prompt to receive the mailing address from the customer 114(1), as shown in interface 710. In step 440, the mailing address is received from customer 114(1) via interface 710 of FIG. 7C, and process 400 proceeds to step 442.

When in step 436, server 300 determines that the received selection of one of the re-ranked modes of transaction is not the Mail a Check mode of transaction or the Cashier's Check mode of transaction, then server 300 takes the No branch and proceeds to step 442.

In step 442, server 300 proceeds to transfer the inputted transfer amount from the selected sender account to the selected recipient account upon receiving a transfer confirmation request. The transfer confirmation request is received upon customer 114(1) selecting the “Continue” button displayed on interface 714. Further, before providing the transfer confirmation request, customer 114(1) may input notes in the “Memo” box to identify the transaction.

In step 402, when server 300 determines that a financial transfer initiation request is not received, then server 300 takes the No branch and proceeds to step 404. In step 404, server 300 determines if a request to receive funds has been received. When server 300 determines that a request to receive funds has been received, then server 300 takes the Yes branch and proceeds to step 444 in FIG. 4C to generate and display a financial requesting interface in response to receiving the request to receive funds. In step 404, when server 300 determines that a request to receive funds has not been received, then server 300 takes the No branch and loops back to step 402.

In step 444, when server 300 determines as the request to receive funds has been received, then server 300 proceeds to generate and display a financial requesting interface. By way of example, first customer 114(1) utilizes a user interface displayed on user device 102(1) to initiate the request to receive funds by accessing a financial banking mobile application stored on user device 102(1). FIG. 8A shows interface 802 that displays the financial banking mobile application with a “Send” icon and a “Request” icon. As explained above, upon customer 114(1) selecting the “Request” icon as shown in interface 802, the request to receive funds is generated and the financial requesting interface 804 including the P2P mode of transaction is displayed. As requesting to receive funds is performed between individual account holders, server 300 selects the P2P mode of transaction as the only mode of transaction.

In step 446, server 300 monitors to determine if a request to access a list of requesting accounts has been received, as shown in interface 804 of FIG. 8A. The list of requesting accounts are accounts from which customer 114(1) would like to send the request to receive funds. Step 446 is substantially similar to step 408 as explained above. In step 446, the list of recipients accounts of step 408 are referred to as the list of requesting accounts.

In step 448, server 300 recommends a list of requesting accounts based at least on analyzing one or more account parameters, as shown in interface 806 of FIG. 8A. Step 448 is substantially similar to step 410 as explained above. In step 448, the list of recipients accounts of step 410 are referred to as the list of requesting accounts.

In step 450, server 300 receives a selection of a requesting account from the list of requesting accounts, as shown in interface 806 of FIG. 8B. Step 450 is substantially similar to step 412 as explained above. In step 450, the list of recipients accounts of step 412 are referred to as the list of requesting accounts.

In step 452, server 300 receives a request to access a list of receiving accounts to receive funds, as shown in interface 808 of FIG. 8B. The list of receiving accounts are accounts into which customer 114(1) would like to receive the funds. Step 452 is substantially similar to step 418 as explained above. In step 452, the list of sender accounts of step 418 are referred to as the list of receiving accounts.

In step 454, the server 300 generates and displays on the financial requesting interface a list of receiving accounts associated with the users account, as shown in interface 810 of FIG. 8B. Step 454 is substantially similar to step 420 as explained above. In step 454, the list of sender accounts of step 420 are referred to as the list of receiving accounts.

In step 456, server 300 receives a selection of the receiving account from the list of receiving accounts, as shown in interface 812 of FIG. 8C. Step 456 is substantially similar to step 422 as explained above. In step 456, the list of sender accounts of step 422 are referred to as the list of receiving accounts.

In step 458, server 300 receives an input of a requesting amount at the financial requesting interface, as shown in interface 812 of FIG. 8C. Step 458 is substantially similar to step 424 as explained above.

In step 460, server 300 transmits the request to receive funds to the selected requesting account from the selected receiving account, upon receiving a confirmation for requesting of the requested amount, as shown in interface 814 of FIG. 8C. The transfer confirmation request is received upon the customer 114(1) selecting the “Continue” button displayed on interface 814. Further, before providing the transfer confirmation request, customer 114(1) may input notes in the “Memo” box to identify the transaction.

The disclosed embodiments provide an improved method of automatically selecting a plurality of modes of transaction based on recipient account identifiers, further ranking the selected modes of transaction based on transfer parameters. By automatically selecting a plurality of modes of transaction and ranking the selected modes of transaction, the disclosed embodiments provide improved financial transactions that gives the customer 114(1) a seamless method of financial transaction by taking into consideration account parameters and transfer parameters. Further, the disclosed embodiments provide the advantages of an optimized user experience with minimal input from the customer.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The elements in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit being indicated by the following claims and their full scope of equivalents.

1. A system for automatically determining a mode of financial transaction to utilize for a financial transaction based on account identifiers associated with participants of the financial transaction, the system comprising:
one or more memory devices storing instructions; and
one or more processors configured to execute the instructions to:
generate and present at a user device, a financial transfer interface in response to receiving from the user device a financial transfer initiation request for a financial transfer, wherein the financial transaction comprises the financial transfer;
receive, from the user device, a selection of a sender account corresponding to a sender participant from a list of sender accounts displayed on the financial transfer interface;
apply a machine learning algorithm to recommend, by displaying on the financial transfer interface, a list of recipient account identifiers corresponding to a plurality of recipient participants of the financial transfer based on analyzing one or more account parameters associated with the sender participant of the financial transfer, wherein the machine learning model comprises inductive logic programming and iteratively updates its algorithm each time users make financial transactions to increase its recommendation accuracy;
receive a selection of one recipient account identifier from the recommended list of recipient account identifiers from the user device, wherein the selected recipient account identifier corresponds to one recipient participant from the plurality of recipient participants;
determine a plurality of modes of financial transaction to perform the financial transfer based on the selected recipient account identifier, wherein at least one of the plurality of modes of financial transaction includes one or more transfer parameters;
rank and display by rank on the financial transfer interface the plurality of modes of financial transaction based on one or more transaction rules associated with the one or more transfer parameters;
receive a selection of one mode of financial transaction from the plurality of modes of financial transaction from the user device;
receive a transfer amount for the financial transfer via the financial transfer interface as an input from the user device; and
upon receiving a transfer confirmation request from the user device, transfer the transfer amount from the sender account corresponding to the sender participant to the selected recipient account identifier corresponding to one of the recipient participants by utilizing the selected mode of financial transaction.

2. The system of claim 1, the one or more processors being further configured to execute instructions to: generating the list of sender accounts displayed on the financial transfer interface based on receiving, from the user device, a selection of an icon on the financial transfer interface.

3. The system of claim 1, the one or more processors being further configured to execute instructions to:
determine if the received transfer amount exceeds a threshold value; and
update the one or more transfer parameters associated with the at least one of the plurality of modes of financial transaction, when the determination regarding the transfer amount indicates that the received transfer amount exceeds the threshold value.

4. The system of claim 3, the one or more processors being further configured to execute instructions to:
re-rank and display on the financial transfer interface the plurality of modes of financial transaction based on the one or more transaction rules associated with the updated one or more transfer parameters.

5. The system of claim 1, the one or more processors being further configured to execute instructions to:
determine if the selected mode of financial transaction requires mailing a physical check;
generating a prompt on the financial transfer interface for the user to provide a mailing address; and
receiving the mailing address as an input via the financial transfer interface from the user device.

6. The system of claim 1, wherein the one or more account parameters includes at least one of user financial transaction history, email history, or text messages associated with the sender participant.

7. The system of claim 1, wherein the one or more transfer parameters includes at least one of a time period required for a wire transfer for the financial transaction, a time period required for processing a check associated with the financial transaction, a service fee associated with the wire transfer for the financial transaction, or a time period required for a transfer between accounts for the financial transaction.

8. (canceled)

9. A computer implemented method for automatically determining a mode of financial transaction to utilize for a financial transaction based on account identifiers associated with participants of the financial transaction, the method comprising:
generating and presenting at a user device, a financial transfer interface in response to receiving from the user device a financial transfer initiation request for a financial transfer, wherein the financial transaction comprises the financial transfer;
receiving, from the user device, a selection of a sender account corresponding to a sender participant from a list of sender accounts displayed on the financial transfer interface;
applying a machine learning algorithm to recommend, by displaying on the financial transfer interface, a list of recipient account identifiers corresponding to a plurality of recipient participants of the financial transfer based on analyzing one or more account parameters associated with the sender participant of the financial transfer, wherein the machine learning model comprises inductive logic programming and iteratively updates its algorithm each time users make financial transactions to increase its recommendation accuracy;
receiving a selection of one recipient account identifier from the recommended list of recipient account identifiers from the user device, wherein the selected recipient account identifier corresponds to one recipient participant from the plurality of recipient participants;
determining a plurality of modes of financial transaction to perform the financial transfer based on the selected recipient account identifier, wherein at least one of the plurality of modes of financial transaction includes one or more transfer parameters;
ranking and displaying by rank on the financial transfer interface the plurality of modes of financial transaction based on one or more transaction rules associated with the one or more transfer parameters;
receiving a selection of one mode of financial transaction from the plurality of modes of financial transaction from the user device;
receiving a transfer amount for the financial transfer via the financial transfer interface as an input from the user device; and
upon receiving a transfer confirmation request from the user device, transferring the transfer amount from the sender account corresponding to the sender participant to the selected recipient account identifier corresponding to one of the recipient participants by utilizing the selected mode of financial transaction.

10. The method of claim 9, the operations further comprising:
generating the list of sender accounts displayed on the financial transfer interface based on receiving, from the user device, a selection of an icon on the financial transfer interface.

11. The method of claim 9, the operations further comprising:
determining if the received transfer amount exceeds a threshold value; and
updating the one or more transfer parameters associated with the at least one of the plurality of modes of financial transaction, when the determination regarding the transfer amount indicates that the received transfer amount exceeds the threshold value.

12. The method of claim 11, the operations further comprising:
re-ranking and displaying on the financial transfer interface the plurality of modes of financial transaction based on the one or more transaction rules associated with the updated one or more transfer parameters.

13. The method of claim 9, the operations further comprising:
determining if the selected mode of financial transaction requires mailing a physical check;
generating a prompt on the financial transfer interface for the user to provide a mailing address; and
receiving the mailing address as an input via the financial transfer interface from the user device.

14. The method of claim 9, wherein the one or more account parameters includes at least one of user financial transaction history, email history, or text messages associated with the sender participant.

15. The method of claim 9, wherein the one or more transfer parameters includes at least one of a time period required for a wire transfer for the financial transaction, a time period required for processing a check associated with the financial transaction, a service fee associated with the wire transfer for the financial transaction, or a time period required for a transfer between accounts for the financial transaction.

16. A non-transitory computer-readable medium storing instructions executable by one or more processors to perform operations for automatically determining a mode of financial transaction to utilize for a financial transaction based on account identifiers associated with participants of the financial transaction, the operations comprising:
generating and presenting at a user device, a financial transfer interface in response to receiving from the user device a financial transfer initiation request for a financial transfer, wherein the financial transaction comprises the financial transfer;
receiving, from the user device, a selection of a sender account corresponding to a sender participant from a list of sender accounts displayed on the financial transfer interface;
applying a machine learning algorithm to recommend, by displaying on the financial transfer interface, a list of recipient account identifiers corresponding to a plurality of recipient participants of the financial transfer based on analyzing one or more account parameters associated with the sender participant of the financial transfer, wherein the machine learning model comprises inductive logic programming and iteratively updates its algorithm each time users make financial transactions to increase its recommendation accuracy;
receiving a selection of one recipient account identifier from the recommended list of recipient account identifiers from the user device, wherein the selected recipient account identifier corresponds to one recipient participant from the plurality of recipient participants;
determining a plurality of modes of financial transaction to perform the financial transfer based on the selected recipient account identifier, wherein at least one of the plurality of modes of financial transaction includes one or more transfer parameters;
ranking and displaying by rank on the financial transfer interface the plurality of modes of financial transaction based on one or more transaction rules associated with the one or more transfer parameters;
receiving a selection of one mode of financial transaction from the plurality of modes of financial transaction from the user device;
receiving a transfer amount for the financial transfer via the financial transfer interface as an input from the user device; and
upon receiving a transfer confirmation request from the user device, transferring the transfer amount from the sender account corresponding to the sender participant to the selected recipient account identifier corresponding to one of the recipient participants by utilizing the selected mode of financial transaction.

17. The non-transitory computer-readable medium of claim 16, the operations further comprising:
generating the list of sender accounts displayed on the financial transfer interface based on receiving, from the user device, a selection of an icon on the financial transfer interface.

18. The non-transitory computer-readable medium of claim 16, the operations further comprising:
determining if the received transfer amount exceeds a threshold value; and
updating the one or more transfer parameters associated with the at least one of the plurality of modes of financial transaction, when the determination regarding the transfer amount indicates that the received transfer amount exceeds the threshold value.

19. The non-transitory computer-readable medium of claim 18, the operations further comprising:
re-ranking and displaying on the financial transfer interface the plurality of modes of financial transaction based on the one or more transaction rules associated with the updated one or more transfer parameters.

20. The non-transitory computer-readable medium of claim 16, the operations further comprising:
determining if the selected mode of financial transaction requires mailing a physical check; generating a prompt on the financial transfer interface for the user to provide a mailing address; and
receiving the mailing address as an input via the financial transfer interface from the user device.
